(19) United States
(12) Patent Application Publication
(10) Pub. No.: US 2004/0094599 A1
(43) Pub. Date: May 20, 2004

(54) Rework nozzle and method

(76) Inventor: Richard J. Luebs, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/298,422

(22) Filed: Nov. 18, 2002

(51) Int. Cl. B23K 1/00

(52) U.S. Cl. 228/19

(57) ABSTRACT

A rework nozzle comprises a rework duct adapted to direct a high temperature gas flow toward a rework component. The rework nozzle also comprises at least one cooling duct adapted to direct a low temperature gas flow to an area adjacent the component to maintain the adjacent area at a reduced temperature relative to a temperature of the high temperature gas flow.

### TECHNICAL FIELD OF THE INVENTION

The present invention relates generally to the field of electronic equipment and, more particularly, to a rework nozzle and method.

### BACKGROUND OF THE INVENTION

As the functionality and sophistication of electronic equipment increases, the complexity of the electronic equipment also increases. For example, electronic equipment often comprise a single- or multi-layer printed circuit board containing a variety of electronic components, such as application specific integrated circuits. Additionally, the density of the electronic components on the printed circuit board also increases.

In the course of testing, assembly or use, electronic components on the printed circuit board may require removal or replacement. However, the density of the components on the printed circuit board generally makes component replacement a difficult and delicate task. For example, one method for replacing an electronic component includes directing a stream of high temperature gas toward the component to soften or re-liquefy the solder coupling the component to the circuit board. However, adjacent components become a concern because the high temperature gas may re-liquefy adjacent component solder-connections, thereby possibly causing a disconnection between the adjacent component and the circuit board. Additionally, the high temperature gas flow may detrimentally affect the adjacent component.

### SUMMARY OF THE INVENTION

In accordance with one embodiment of the present invention, a rework nozzle comprises a rework duct adapted to direct a high temperature gas flow toward a rework component. The rework nozzle also comprises at least one cooling duct adapted to direct a low temperature gas flow to an area adjacent the component to maintain the adjacent area at a reduced temperature relative to a temperature of the high temperature gas flow.

In accordance with another embodiment of the present invention, a method for producing a rework nozzle comprises providing a rework duct adapted to direct a high temperature gas flow toward a rework component. The method also comprises providing at least one cooling duct adapted to direct a low temperature gas flow to an area adjacent the component to maintain the adjacent area at a reduced temperature relative to a temperature of the high temperature gas flow.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a rework nozzle in accordance with the present invention;

FIG. 2 is a diagram illustrating another embodiment of a rework nozzle in accordance with the present invention; and

FIG. 3 is a diagram illustrating another embodiment of a rework nozzle in accordance with the present invention.

### DETAILED DESCRIPTION OF THE DRAWINGS

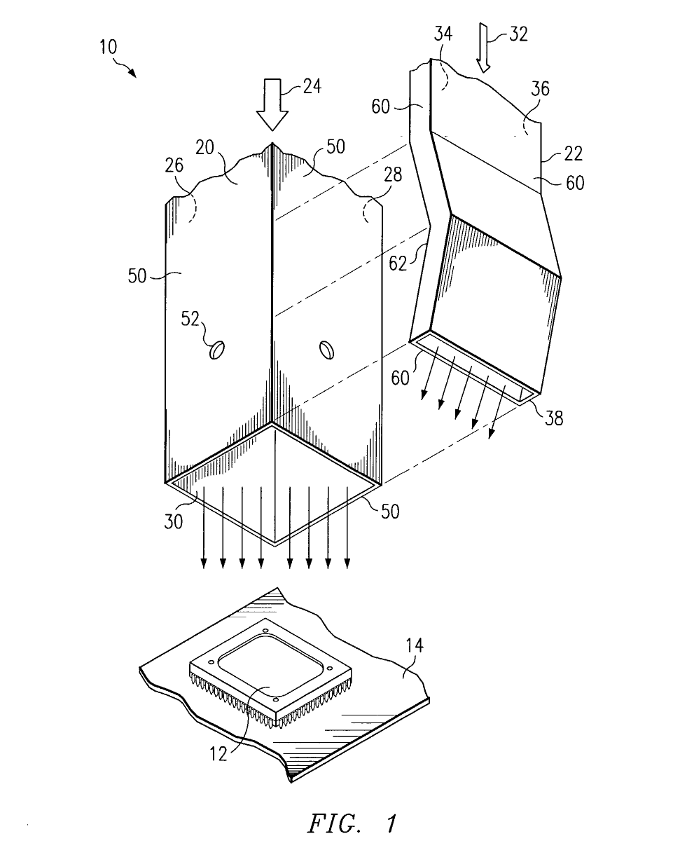

The preferred embodiments of the present invention and the advantages thereof are best understood by referring to FIGS. 1-3 of the drawings, like numerals being used for like and corresponding parts of the various drawings.

FIG. 1 is a diagram illustrating an exploded view of an embodiment of a rework nozzle 10 in accordance with the present invention. Briefly, nozzle 10 is used to enable or assist in the removal of an electronic component 12 from a printed circuit board 14 or other structure. For example, electronic component 12 may comprise an integrated circuit, resistor, capacitor, or any other type of device soldered to printed circuit board 14. Nozzle 10 directs a relatively high temperature gas flow toward component 12 to re-liquefy solder connecting component 12 to printed circuit board 14. Additionally, a relatively cool or lower temperature gas flow is directed toward adjacent areas of printed circuit board 14 to reduce the temperature of the high temperature gas flow to substantially prevent the re-liquefication of solder attachments of adjacent components and maintain the adjacent components at a reduced temperature, thereby protecting adjacent components from elevated temperatures which may otherwise detrimentally affect the adjacent component.

In the embodiment illustrated in FIG. 1, nozzle 10 comprises a rework duct 20 and at least one cooling duct 22. For example, in FIG. 1, a single cooling duct 22 is illustrated; however, it should be understood that additional cooling ducts 22 may be disposed about rework duct 20. Rework duct 20 and cooling duct 22 may comprise any type of structure for directing a gas flow in a desired direction. Briefly, in operation, a high temperature gas flow, indicated generally at 24, is downwardly directed through rework duct 20 from an inlet 26, through an internal area 28, and exits an outlet 30 disposed proximate to component 12. A low temperature gas, indicated generally at 32, is directed through cooling duct 22 from an inlet 34, through an internal area 36, and exits an outlet 38 of cooling duct 22. High temperature gas flow 24 is provided at a temperature to facilitate re-liquefication of solder or other material connecting component 12 to printed circuit board 14. Low temperature gas flow 32 is provided at a temperature lower than high temperature gas flow 24 such that gas flow 32 maintains adjacent areas of printed circuit board 14 at a reduced temperature relative to the temperature of gas flow 24 and/or reduces the temperature of gas flow 24 in areas adjacent to outlet 30 such that components and printed circuit board 14 areas adjacent to component 12 are not subjected to potentially detrimental elevated temperatures.

In the embodiment illustrated in FIG. 1, rework duct 20 comprises a plurality of walls 50 forming a polygonally-shaped outlet 30; however, it should be understood that rework duct 20 may be otherwise geometrically configured. For example, rework duct 20 may also be configured using a single wall 50 to form an elliptical, circular, or other geometrical configuration. Additionally, rework duct 20 and/or outlet 30 may be configured having a geometry corresponding to a geometry of component 12 such that outlet 30 may be disposed over and around component 12, thereby minimizing gas flow 24 from being deflected toward components adjacent to component 12.

As illustrated in FIG. 1, this embodiment of rework duct 20 also comprises a vent 52 formed in each wall 50 for venting a portion of gas flow 24 outwardly from internal area 28. For example, as gas flow 24 exits outlet 30, a portion of gas flow 24 may reflect upwardly from component 12 and return to internal area 28. Thus, vents 52 provide an outlet for a portion of gas flow 24 to exit internal area 28. In the illustrated embodiment, each wall 50 comprises a single vent 52; however, it should be understood that a greater or fewer quantity of vents 52 may be formed in walls 50 of rework duct 20. For example, one or more walls 50 may have no vents 52, a single vent 52, or a plurality of vents 52. Additionally, in the illustrated embodiment, vents 52 are configured having a generally circular geometry; however, it should be understood that other geometries may be used for forming vents 52.

In FIG. 1, cooling ducts 22 are deposed along exterior portions of walls 50 such that outlets 38 of cooling ducts 22 are disposed proximate to outlet 30 of rework duct 20. Cooling duct 22 may also be configured having a plurality of walls 60 forming a polygonally-shaped outlet 38; however, it should be understood that a greater or fewer quantity of walls 60 may be used to form cooling duct 22. For example, a single wall 60 may be used to form cooling duct 22 having an elliptical, circular, or other geometrical configuration.

In the embodiment illustrated in FIG. 1, cooling duct 22 is configured having a longitudinal length such that outlet 38 is disposed adjacent to outlet 30. However, it should be understood that the longitudinal length of cooling duct 22 may be otherwise configured such that outlet 38 is disposed at other longitudinal locations relative to outlet 30. For example, nozzle 10 may be configured such that outlet 38 extends below outlet 30, or outlet 30 may be configured to extend below outlet 38. Additionally, in the embodiment illustrated in FIG. 1, cooling duct 22 is configured having a lateral width substantially equal to a lateral width of walls 50 of rework duct 20. However, it should be understood that cooling duct 22 may be otherwise configured such that outlet 38 may extend to different lateral locations relative to outlet 30.

As illustrated in FIG. 1, cooling duct 22 is configured having an outwardly extending portion 62 to form a gap or clearance area between cooling duct 22 and wall 50 of rework duct 20 proximate to vent 52. For example, cooling duct 24 is configured such that portions of air flow 24 exiting vents 52 pass between an exterior portion of wall 50 and a portion of wall 60 facing wall 50. Thus, gas flow 24 exiting vents 52 may be directed laterally to either side of cooling duct 22. In the illustrated embodiment, rework duct 60 is formed having an outwardly extending bend disposed proximate to vent 52 to form portion 62; however, cooling duct 22 may be otherwise configured to form a gap between cooling duct 22 and rework duct 20 proximate to locations of vents 52.

Thus, in operation, high temperature gas flow 24 is directed downwardly toward component 12 by rework duct 20. Portions of gas flow 24 that reflect upwardly from component 12 may be directed outwardly via vents 52. Additionally, as portions of gas flow 24 exit vents 52, the exiting gas flow 24 is directed laterally relative to a longitudinal direction of nozzle 10, thereby substantially preventing gas flow 24 from being directed downwardly toward adjacent components. Additionally, low temperature gas flow 32 is directed downwardly via cooling duct(s) 22 such that as gas flow 32 exits outlet 38, gas flow 32 reduces the temperature of gas flow 24 flowing adjacent to component 12, thereby substantially decreasing the likelihood that elevated temperatures will detrimentally affect components adjacent to component 12.

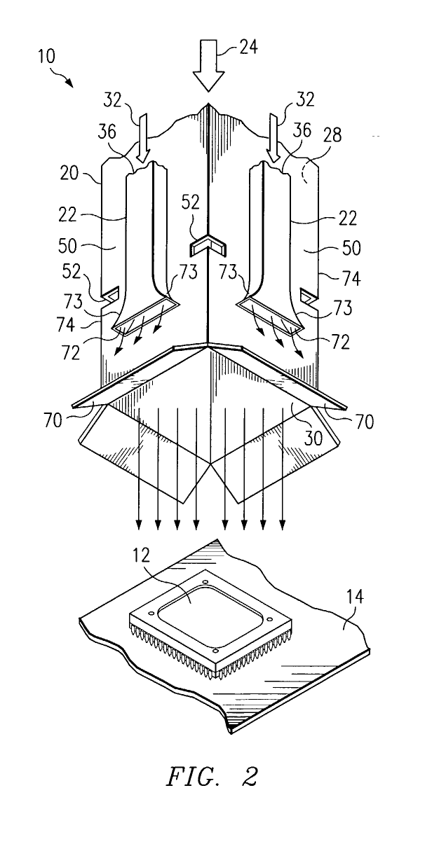

FIG. 2 is a diagram illustrating another embodiment of nozzle 10 in accordance with the present invention. In the embodiment illustrated in FIG. 2, rework duct 20 is configured having at least one deflector 70 adapted to deflect air flow 32 to adjacent areas of printed circuit board 14. For example, in the embodiment illustrated in FIG. 2, deflector 70 comprises a flange 72 extending outwardly from walls 50 and disposed proximate to outlet 30. In the embodiment illustrated in FIG. 2, flanges 72 are disposed substantially perpendicular to a longitudinal direction of rework duct 20; however, it should be understood that other angular orientations of flanges 72 relative to the longitudinal direction of rework duct 20 may be used. Additionally, in the embodiment illustrated in FIG. 2, deflectors 70 are positioned adjacent each wall 50 such that deflectors 70 are disposed about an entire perimeter of outlet 30. However, it should be understood that a greater or fewer quantity of deflectors 70 may be used.

In the embodiment illustrated in FIG. 2, rework duct 20 comprises at least one deflector 70 to deflect air flow 32 toward adjacent areas of printed circuit board 14. However, it should also be understood that rework nozzle 10 may be otherwise configured to direct air flow 32 toward adjacent areas. For example, cooling duct 22 may be configured such that outlet 72 is angled or directed away from duct 20 and towards adjacent areas, thereby enabling duct 10 to be configured without deflectors 70.

In the embodiment illustrated in FIG. 2, outlet 72 of cooling duct 22 comprises outwardly flared or divergent walls 73 to direct gas flow 32 downwardly and outwardly to adjacent areas of printed circuit board 14. Additionally, in the embodiment illustrated in FIG. 2, vents 52 are formed having a rectangular-shaped geometry disposed along corners 74 of rework duct 20. Outlets 74 are disposed spaced apart from deflectors 70 such that air flow 32 exiting outlets 74 is downwardly directed and outwardly deflected via deflectors 70. Thus, in operation, gas flow 24 is directed downwardly through outlet 30 toward component 12 to soften or re-liquefy solder connecting component 12 to printed circuit board 14. As described above, a portion of gas flow 24 may reflect upwardly from component 12 and re-enter rework duct 20. Vents 50 provide an exit path for a portion of gas flow 24 as described above. Additionally, gas flow 32 travels downwardly via cooling ducts 22 and exits outlets 74. As gas flow 32 exits outlets 74, gas flow 32 deflects against deflectors 70, thereby directing gas flow 32 outwardly to adjacent areas of printed circuit board 14 and toward adjacent components on printed circuit board 14, thereby substantially preventing elevated temperatures from affecting adjacent components. Additionally, as gas flow 32 exits outlets 74, a portion of gas flow 32 may mix with gas flow 24 exiting outlet 30, thereby reducing the temperature of gas flow 24 exterior to rework duct 20.

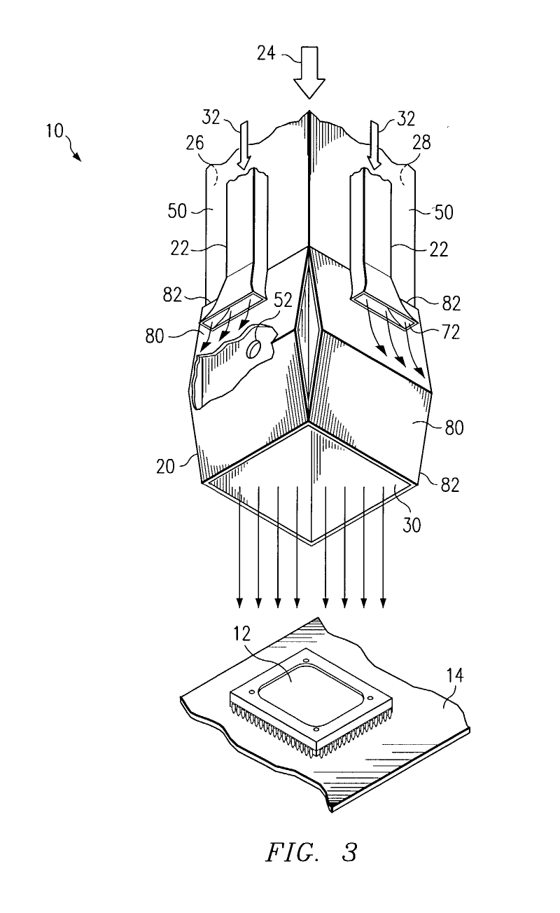

FIG. 3 is a diagram illustrating another embodiment of nozzle 10 in accordance with the present invention. In the embodiment illustrated in FIG. 3, rework duct 20 comprises a plurality of flaps 80 disposed about a downward portion 82 of rework duct 20. In the illustrated embodiment of FIG. 3, flaps 80 are formed as integral components of rework duct 20 by bending portions of walls 50 upwardly and exterior to internal area 28 of duct 20. For example, flaps 80 may be formed by bending a portion of each wall 50 upwardly towards inlet 26. Upward portions 82 of flaps 80 may be secured to walls 50 by welding or other coupling methods. Additionally, in the embodiment illustrated in FIG. 3, a portion of flap 80 is disposed spaced apart from wall 50 to form or create a gap between flap 80 and wall 50 in an area proximate to vents 52 such that a portion of air flow 24 may exit vents 52 and be deflected outwardly to each side of flap 80. Thus, in operation, as described above, air flow 32 exiting outlets 72 of cooling ducts 22 is downwardly directed to reduce a temperature of gas flow 24 that may flow outwardly toward adjacent components. Additionally, a portion of air flow 24 deflected from component 12 and into internal area 28 of duct 20 may exit internal area 28 of duct 20 via vents 52 and outwardly from between flaps 80 and walls 50.

What is claimed is:

1. A rework nozzle, comprising:
a rework duct adapted to direct a high temperature gas flow toward a rework component; and
at least one cooling duct adapted to direct a low temperature gas flow to an area adjacent the component to maintain the adjacent area at a reduced temperature relative to a temperature of the high temperature gas flow.

2. The nozzle of claim 1, wherein the rework duct comprises a plurality of walls.

3. The nozzle of claim 1, further comprising a deflector adapted to deflect the low temperature gas flow toward the adjacent area.

4. The nozzle of claim 1, further comprising at least one vent disposed in a wall of the rework duct.

5. The nozzle of claim 1, wherein the rework duct comprises at least one external flap.

6. The nozzle of claim 1, wherein the rework duct comprises at least one external flap disposed relative to a vent to deflect the high temperature gas flow exiting the vent.

7. The nozzle of claim 1, wherein an outlet of the rework duct is geometrically configured to correspond with a geometry of the rework component.

8. The nozzle of claim 1, further comprising at least one outwardly extending flange disposed spaced apart from an outlet of the cooling duct and adapted to deflect the low temperature gas flow toward the adjacent area.

9. The nozzle of claim 1, wherein an outlet of the cooling duct comprises at least one flared wall.

10. The nozzle of claim 1, wherein the cooling duct comprises an outlet extending a width of an outlet of the rework duct.

11. A method for producing a rework nozzle, comprising:
providing a rework duct adapted to direct a high temperature gas flow toward a rework component; and
providing at least one cooling duct adapted to direct a low temperature gas flow to an area adjacent the component to maintain the adjacent area at a reduced temperature relative to a temperature of the high temperature gas flow.

12. The method of claim 11, further comprising providing a deflector adapted to deflect the low temperature gas flow towards the adjacent area.

13. The method of claim 11, further comprising configuring the outlet to correspond with a geometry of the rework component.

14. The method of claim 11, further comprising providing a vent disposed in a wall of the rework duct.

15. The method of claim 14, further comprising providing a flap adapted to deflect the high temperature gas flow exiting the vent.

16. The method of claim 11, further comprising a flap disposed relative to a vent formed in a wall of the rework duct, the flap adapted to laterally deflect the high temperature gas flow exiting the vent.

17. The method of claim 11, further comprising providing a deflector disposed spaced apart from an outlet of the cooling duct.

18. The method of claim 11, wherein providing a cooling duct comprises providing an outlet of a cooling duct having at least one outwardly flared wall.

19. The method of claim 11, wherein providing a cooling duct comprises providing a cooling duct having an outlet extending a distance corresponding to a width of an outlet of the rework duct.

20. A rework nozzle, comprising:
means for directing a high temperature gas flow toward a rework component; and
means for directing a low temperature gas flow to an area adjacent the component to maintain the adjacent area at a reduced temperature relative to a temperature of the high temperature gas flow.

21. The nozzle of claim 20, further comprising means for directing a portion of the high temperature gas flow through a wall of the means for directing the high temperature gas flow.

22. The nozzle of claim 20, wherein the outlet of the means for directing the high temperature gas flow is configured having a geometry corresponding to a geometry of the rework component.

23. The nozzle of claim 20, further comprising means for deflecting the high temperature gas flow exiting a vent disposed in a wall of the means for directing the high temperature gas flow.

24. The nozzle of claim 20, wherein the means for directing the low temperature gas flow comprises an outlet extending a distance corresponding to a width of the outlet of the means for directing the high temperature gas flow.

25. The nozzle of claim 20, further comprising means for deflecting the low temperature gas flow toward the adjacent area.

26. The nozzle of claim 20, further comprising means for laterally venting a portion of the high temperature gas flow.
